(19) United States
(12) Patent Application Publication
(10) Pub. No.: US 2025/0231311 A1
(43) Pub. Date: Jul. 17, 2025

(54) Generating Seismic Images of a Subsurface Formation

(71) Applicant: Saudi Arabian Oil Company, Dhahran (SA)

(72) Inventors: Bingbing Sun, Dhahran (SA); Eyad F. Aljishi, Dhahran (SA); Abdulmohsen M. AlAli, Dammam (SA); Nasher Muqbel AlbinHassan, Dammam (SA)

(21) Appl. No.: 18/413,985

(22) Filed: Jan. 16, 2024

(51) Int. Cl. G01V 1/48; G06N 3/08

(52) U.S. Cl. CPC G01V 1/48; G06N 3/08; G01V 2210/614; G01V 2210/6222; G01V 2210/675

(57) ABSTRACT

Systems and methods for generating seismic images of a subsurface formation include obtaining seismic data representing the subsurface formation. Velocity models are generated for the subsurface formation based on the seismic data. Green's functions for the subsurface formation are predicted using a neural network, where the inputs to the neural network include the velocity models, and seismic images of the subsurface formation are generated based on the seismic data and the predicted Green's functions.

### TECHNICAL FIELD

This disclosure generally relates to geological exploration of a subsurface formation.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications such as, for example, identification of potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

### SUMMARY

This disclosure describes systems and methods for constructing seismic images of a subsurface formation. A data processing system (e.g., a computer or control system) obtains seismic data representing the subsurface formation. The data processing system generates velocity models for the subsurface formation based on the seismic data. The data processing system predicts Green's functions for the subsurface formation using a neural network, where the inputs to the neural network include the velocity models; and the data processing system generates seismic images of the subsurface formation based on the seismic data and the determined Green's functions.

Implementations of the systems and methods of this disclosure can provide various technical benefits. Determining Green's functions using a neural network reduces computation time (e.g., up to 10 times reduction) compared with determining Green's functions using finite difference methods. A Green's function generated by a neural network can capture complex physics of seismic wave propagation in the subsurface formation while also producing outputs (e.g., common offset gathers, angle domain common image gathers) to evaluate the accuracy of the velocity models. Using a neural network to generate a Green's function provides flexibility in producing seismic wavefields for complex subsurface formations while retaining accuracy.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey being performed to map subsurface features such as facies and faults.

FIG. 2 is a schematic of a diffraction stack migration operator superimposed on seismic data.

FIG. 3 is a schematic of generalized diffraction stack migration.

FIG. 4 is a workflow for constructing seismic images using a Green's function generated with a neural network.

FIG. 5 is a method for constructing seismic images using a Green's function generated with a neural network.

FIG. 6 illustrates hydrocarbon production operations that include field operations and computational operations, according to some implementations.

FIG. 7 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for constructing seismic images of a subsurface formation. A data processing system (e.g., a computer or control system) obtains seismic data representing the subsurface formation. The data processing system generates velocity models for the subsurface formation based on the seismic data. The data processing system predicts Green's functions for the subsurface formation using a neural network, where the inputs to the neural network include the velocity models; and the data processing system generates seismic images of the subsurface formation based on the seismic data and the determined Green's functions.

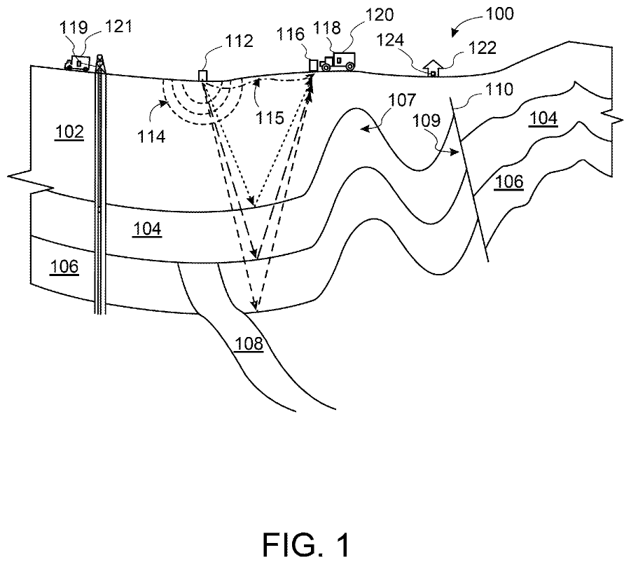

FIG. 1 is a schematic view of a seismic survey being performed to map subsurface features such as facies and faults in a subsurface formation 100. The subsurface formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subsurface formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems. In some implementations, results generated by the computer system 124 may be displayed for user viewing using local or remote monitors or other display units.

Seismic migration is a technique for relocating reflection events back to their interface origins in the earth subsurface. The reflectivity associated with impedance contrast in the subsurface formation can reveal complex structures such as faults, channels and salt bodies within the subsurface formation.

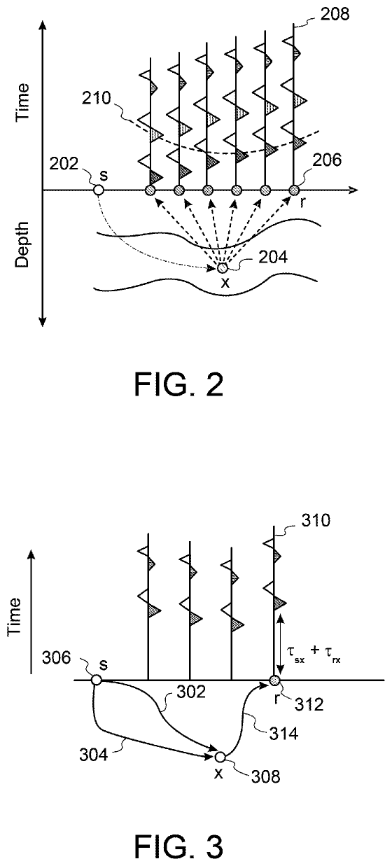

FIG. 2 is a schematic example of a diffraction-stack migration (e.g., Kirchhoff Migration) method for constructing seismic images. The diffraction-stack migration method can be flexible and efficient for some subsurface formations (e.g., subsurface formations with complex subsurface velocities). A seismic wave is emitted by a source 202. The seismic wave reflects and scatters from a point 204 (x) within the subsurface formation. The reflected and scattered seismic wave is received by multiple receivers 206 located at the surface of the subsurface formation. Each receiver 206 generates a trace 208 forming a record of the received seismic waves. The dashed curved line 210 represents the diffraction-stack migration operator.

The diffraction-stack migration method backpropagates the energy of a single event in a trace to all possible subsurface reflection points. By summing the energy of the events in the traces, the final image is obtained. The energy propagation uses a Green's function that represents the response for given source and receiver positions. Generally, Green's functions are integral kernels that can be used to solve differential equations and, for example, allow for visual interpretations of actions associated with a source of force. The Green's function is useful for constructing seismic images from the seismic data. The Green's function computation is inexpensive for the diffraction-stack migration method because the diffraction-stack migration method is subject to high-frequency asymptotic approximation of ray tracing. The ray tracing solves an ordinary differential equation as compared with solving a partial differential equation, which can be more complex and time consuming. The diffraction-stack migration can easily be adapted to different filtering strategies such as obliquity factors, angle-dependent truncation of data aperture (e.g., producing common offset gathers), and antialiasing filters. However, the high-frequency asymptotic approximation can have difficulty with complex velocity models. A simple velocity model is approximately flat with minor variations while a complex velocity model has strong lateral velocity variations such as near surface effects or salt bodies.

Another method for determining a Green's function to construct seismic images is the reverse time migration (RTM) method, which determines the Green's function using finite difference methods. For example, the seismic wave is forward propagated from the source, the seismic traces are backward propagated from the receivers, and zero-lag cross correlation can be applied to seismic images to identify the scattering point. The RTM method leads to a more accurate imaging algorithm for complex velocity models as compared with the diffraction-stack migration method. When considering computational efficiency, the Green's function in RTM is computed for a common shot gather (CSG) without separation for each receiver. Thus, the RTM method is relatively less flexible than Kirchhoff migration, where conventional RTM can neither produce common offset gathers (COGs) nor the angle domain common image gathers (ADCIGs) which are used for evaluating the accuracy of the velocity models. COGs include seismic traces having the same source to receiver distance (offset).

FIG. 3 depicts a generalized diffraction stack migration (GDSM), which combines features of the diffraction-stack migration and the RTM into a single framework. Seismic waves 302, 304 are forward propagated from source 306 to point 308. A Green's function is determined to characterize the response at point 308. Data from trace 310 is back propagated from receiver 312 to point 308, and a Green's function is determined to characterize the response from the backpropagated data. The two Green's functions are convolved to reconstruct the trace 310 received at the receiver 312 from the seismic waves 302, 304 emitted from the source 306 and the reflected and scattered waves 314 from the point 308.

The GDSM computation can be relatively expensive, requiring calculating the response between each pair of points in the subsurface. With aperture control (e.g., controlling the dataset for migration based on offset information) some of the Green's functions may not need to be determined. The computational expense of determining the Green's functions can be an impediment for industrial applications of the GDSM method, particularly for elastic cases where the Green's functions are simulated by solving wave equations using finite-difference methods.

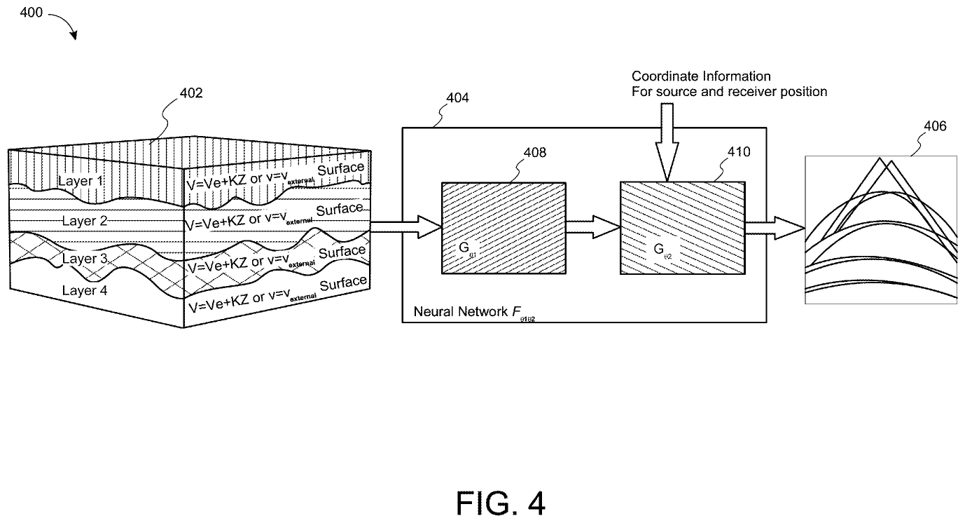

FIG. 4 is an example workflow 400 for constructing seismic images using Green's functions determined using a trained neural network 404. The neural network 404 takes as input velocity models 402 and outputs Green's functions corresponding to source and receiver positions. The Green's functions are used to construct seismic images 406. The neural network 404 is trained to learn the Green's functions to produce seismic traces between arbitrary positions in the subsurface. The seismic migration method using the machine-learned Green's functions results in imaging as accurate as the RTM method and as flexible as diffraction stack migration. The workflow 400 can output COGs which represent nonphysical aspects that cannot be obtained in an RTM based method.

The neural network 404 is trained to predict a Green's function using supervised learning. A labeled dataset, (xᵢ, yᵢ), where xᵢ is the velocity model, (e.g., velocity model 402) that can be a 3D volume, and yᵢ represents the Green's functions and includes multiple traces for different source and receiver pairs: yᵢ=[yᵢ^{q}^{₁}^{,p}^{₁}, yᵢ^{q}^{₂}^{,p}^{₂}, yᵢ^{q}^{₃}^{,p}^{₃}, . . . yᵢ^{q}^{ₘ}^{,p}^{ₘ}], where q₁, p₁ denote the source and receiver position for a single Green's function, each yᵢ^{q}^{₁}^{,p}^{₁} is a vector indexed by time, and m is the total number of Green's functions in the labeled dataset. The Green's functions can be computed using numerical simulation methods such as finite-difference and finite-element methods. Based on the imaging requirement, different simulation engines can be selected for generating the Green's functions. For example, in the case of elastic modeling, a simulation engine is selected that can determine P wave and S wave velocity models as well as the density for points x in the subsurface. The corresponding Green's function, yᵢ, includes both vertical and horizontal components. The size and/or dimensions of the inputs and outputs of the machine learning model can be adapted for specific applications.

The neural network 404 can be denoted as F_{θ}(xᵢ; qᵢ^{j}, pᵢ^{j}, j=1, . . . m). The following misfit function based on mean square errors (MSEs) can be used to train the neural network:

$$J ( θ ) = {\sum }_{i = 1}^{n} {‖ {F}_{θ} ( {x}_{i} ; {q}_{i}^{j} , {p}_{i}^{j} , j = 1 , … m ) - {y}_{i} ‖}_{2}^{2} ,$$

where n denotes the batch size, e.g., how many sample pairs are used in a single step of training the neural network. When the loss function is well defined, the gradient of the loss function can be determined through differentiation and the parameters of the neural network θ can be updated through backward propagation:

$$θ ← θ + γ \frac{dJ ( θ )}{d θ} ,$$

where γ is the learning rate. The values of θ are updated during training until a specific number of iterations or a specified prediction accuracy is achieved.

The neural network 404, F_{θ}, takes as input a 3D velocity model 402 and produces a batch of Green's function in 1D vector forms. As shown in FIG. 4, the neural network 404 is split into two parts 408, 410, the velocity model feature extraction part 408, G_{θ}_{₁}(xᵢ), and the wavefield generation part 410, G_{θ}_{₂}(G_{θ}_{₁}(xᵢ), qᵢ^{j}, pᵢ^{j}). Thus, the neural network F_{θ}=F_{θ}_{₁}_{,θ}_{₂} can be expressed as:

$${F}_{{θ}_{1} , {θ}_{2}} ( {x}_{i} ; {q}_{i}^{j} , {p}_{i}^{j} , j = 1 , … m ) = [ {G}_{{θ}_{2}} ( {G}_{{θ}_{1}} ( {x}_{i} ) , {q}_{i}^{1} , {p}_{i}^{1} ) , {G}_{{θ}_{2}} ( {G}_{{θ}_{1}} ( {x}_{i} ) , {q}_{i}^{2} , {p}_{i}^{2} ) , … , {G}_{{θ}_{2}} ( {G}_{{θ}_{1}} ( {x}_{i} ) , {q}_{i}^{m} , {p}_{i}^{m} ) ] ,$$

In the velocity model feature extraction stage 408, the neural network G_{θ}_{₁}(xᵢ) takes the velocity model 402 as input and outputs the extracted features. In the wavefield generating stage 410, the neural network G_{θ}_{₂}(G_{θ}_{₁}(xᵢ), qᵢ^{j}, pᵢ^{j}) takes as input the extracted features and coordinates for the source and receiver pair to include the position information for the Green's function. The separation of the neural network 404 into two parts 408, 410 makes training the machine learning model easier and more stable. For example, through the two part design the Green's functions are generated for a specific velocity model, and they only differ in their source and receiver positions.

A variety of neural network architectures can be used for the neural network G_{θ}_{₁}(xᵢ) and G_{θ}_{₂}(G_{θ}_{₁}(xᵢ), qᵢ^{j}, pᵢ^{j}). For example, G_{θ}_{₁}(xᵢ) can be a U-net while G_{θ}_{₂}(G_{θ}_{₁}(xᵢ), qᵢ^{j}, pᵢ^{j}) can be a transformer network. A U-net, for example, is a convolutional neural network with a contracting path and an expanding path. The contracting path can reduce the size of the data through convolutions and max pooling operations. This reduces spatial information while increasing feature information. The expansion path includes up-convolutions and concatenations with features from the contracting path. A transformer network, for example, can include an encoder and/or a decoder that transforms the input through a series of attention and feedforward layers. The inclusion of the source and receiver coordinates in G_{θ}_{₂}(G_{θ}_{₁}(xᵢ), qᵢ^{j}, pᵢ^{j}) can utilize the positional encoding schemes in a transformer network.

The seismic image can be constructed based on the GDSM framework using the following equation:

$$IMAGE ( x ) = \int \int \int G ( r , s , x , t ) d ( r , t \vert s ) dsdrdt , \qquad ( 1 )$$

Here G(r, s, x, t) is the GDSM kernel, which is constructed by convolution of two Green's functions predicted by the neural network 404:

$$G ( r , s , x , t ) = g ( x , t \vert s ) * g ( r , t \vert x ) , \qquad ( 2 )$$

where g(x, t|s) and g(r, t|x), are Green's functions that represent wave propagation from source s to position x and from source x to position r, respectively. Both Green's functions are predicted by the neural network 404.

For each position in the subsurface and for each source and receiver pair, the neural network predicts a Green's function. The imaging kernel is combined with the seismic data d(r, t|s) (e.g., using a dot product according to equation (1)). The combined result is added to the corresponding location in the seismic image. In some implementations, the seismic image is a three-dimensional image volume.

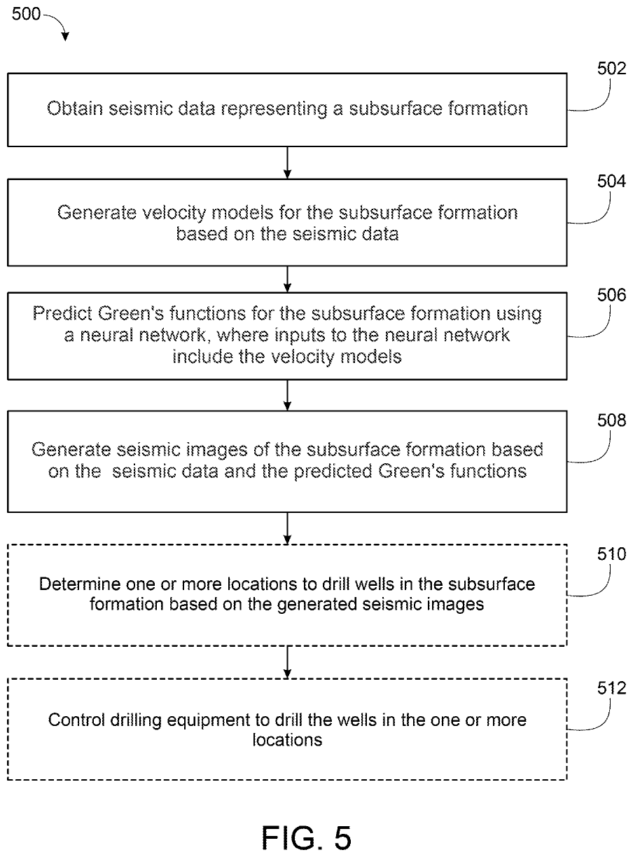

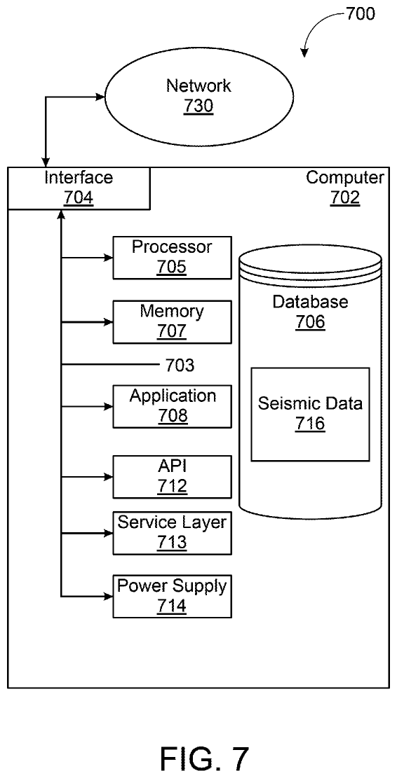

FIG. 5 is an example method 500 for constructing seismic images for a subsurface formation. The method 500 can be implemented on a data processing system such as a computer system or control system (e.g., the computer system 124 or the computer system of FIG. 7). The data processing system can be a part of a high-performance computing system that utilizes parallel implementations and clustered processors.

The data processing system obtains seismic data representing the subsurface formation (step 502). For example, the data processing system records the seismic data during a seismic operation (e.g., the seismic survey depicted in FIG. 1). In some implementations, the data processing system accesses the seismic data from a data store.

The data processing system generates velocity models for the subsurface formation based on the seismic data (step 504). For example, the data processing system can generate velocity models by applying a seismic tomography technique to the seismic data.

The data processing system predicts Green's functions for the subsurface formation using a neural network (step 506). The inputs to the neural network include the velocity models. In some implementations, the inputs also include positions of seismic sources and receivers. In some implementations, the neural network includes a transformer network or a U-network. In some implementations, the neural network is a combination of two neural networks, where the first of the two neural networks extracts features from the velocity models, and the second of the two neural networks takes as input the extracted features and coordinates for source and receiver pairs and outputs the predicted Green's functions. The first neural network can be a U-network and the second neural network can be a transformer network.

In some implementations, the data processing system trains the neural network based on a training dataset that includes velocity models labeled with corresponding Green's functions. The training dataset can include synthetically generated velocity models, where the velocity models are derived from a geological model. The corresponding Green's functions can be determined based on a simulation of seismic wave propagation from a source location to a receiver location. The simulation can include finite-difference or finite-element simulations.

The data processing system generates seismic images of the subsurface formation based on the seismic data and the predicted Green's functions (step 508). For example, for each position in the subsurface formation and for each source and receiver pair, the data processing system receives the corresponding Green's function (e.g., from the neural network or from a data store). The data processing system determines an imaging kernel based on the Green's function. The data processing system combines the imaging kernel with the seismic data. The data processing system fills the corresponding location in the image (or image volume) with the combined result.

In some implementations, the data processing system determines one or more locations to drill wells in the subsurface formation based on the generated seismic images. For example, the data processing system can identify locations in the subsurface formation that are likely to hold hydrocarbons based on features in the seismic images.

In some implementations, the data processing system controls drilling equipment to drill wells at the determined locations. For example, the data processing system can generate control commands for the drilling equipment (on-site or remotely) based on the generated seismic images to drill the wells at the determined locations. The seismic images indicate, for example, types and locations of rock in the subsurface that can be used to determine drilling parameters (e.g., drilling speed).

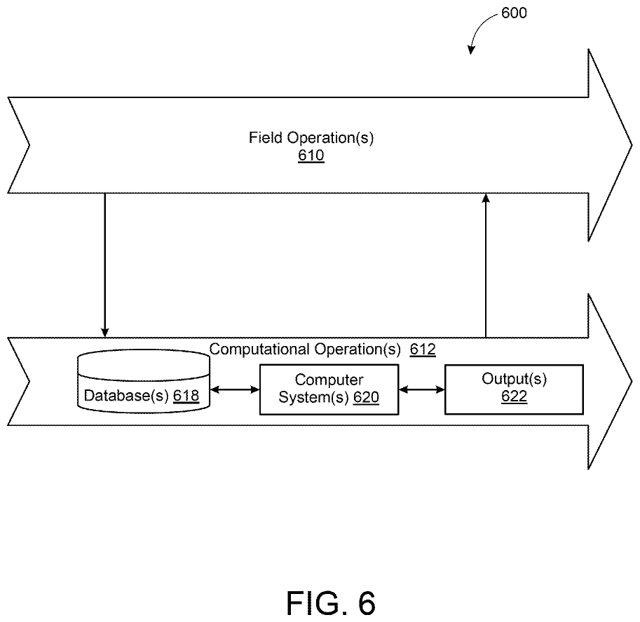

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure (e.g., the method 500) can be performed before, during, or in combination with the hydrocarbon production operations 600, specifically, for example, either as field operations 610 or computational operations 612, or both.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively, or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can hold seismic data 716. For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### Examples

In an example implementation, a method for generating seismic images of a subsurface formation includes obtaining seismic data representing the subsurface formation; generating velocity models for the subsurface formation based on the seismic data; predicting Green's functions for the subsurface formation using a neural network, where the inputs to the neural network comprise the velocity models; and generating seismic images of the subsurface formation based on the seismic data and the predicted Green's functions.

An aspect combinable with the example implementation includes determining one or more locations to drill wells in the subsurface formation based on the generated seismic images; and controlling drilling equipment to drill the wells in the one or more locations.

In another aspect combinable with any of the previous aspects, generating the velocity models include generating the velocity models by applying a seismic tomography technique to the seismic data.

Another aspect combinable with any of the previous aspects includes training the neural network based on a training data set comprising velocity models labeled with corresponding Green's functions.

In another aspect combinable with any of the previous aspects, the training data set includes synthetically generated velocity models and corresponding Green's functions.

In another aspect combinable with any of the previous aspects, the synthetically generated velocity models are derived from a geological model, and the corresponding Green's functions are determined based on a simulation of seismic wave propagation from a source location to a receiver location.

In another aspect combinable with any of the previous aspects, the neural network includes a transformer network or a U-network.

In another aspect combinable with any of the previous aspects, predicting the Green's functions for the subsurface formation includes extracting features from the velocity models using a first neural network; and generating wavefields using a second neural network, where the first neural network takes as input the velocity models and outputs the extracted features, and the second neural network takes as input the extracted features and locations of source and receiver pairs and outputs the predicted Green's functions.

In another aspect combinable with any of the previous aspects, the first neural network includes a U-network, and the second neural network includes a transformer network.

In another example implementation, a system for generating seismic images of a subsurface formation includes at least one processor and a memory storing instructions that when executed by the at least one processor cause the at least one processor to perform operations including obtaining seismic data representing the subsurface formation; generating velocity models for the subsurface formation based on the seismic data; predicting Green's functions for the subsurface formation using a neural network, where the inputs to the neural network comprise the velocity models; and generating seismic images of the subsurface formation based on the seismic data and the predicted Green's functions.

In an aspect combinable with the example implementation, the operations include determining one or more locations to drill wells in the subsurface formation based on the generated seismic images; and controlling drilling equipment to drill the wells in the one or more locations.

In another aspect combinable with any of the previous aspects, generating the velocity models includes generating the velocity models by applying a seismic tomography technique to the seismic data.

In another aspect combinable with any of the previous aspects, the operations include training the neural network based on a training data set including velocity models labeled with corresponding Green's functions.

In another aspect combinable with any of the previous aspects, the training data set includes synthetically generated velocity models derived from a geological model, and corresponding Green's functions determined based on a simulation of seismic wave propagation from a source location to a receiver location.

In another aspect combinable with any of the previous aspects, predicting the Green's functions for the subsurface formation includes extracting features from the velocity models using a first neural network; and generating wavefields using a second neural network, where the first neural network takes as input the velocity models and outputs the extracted features, and where the second neural network takes as input the extracted features and locations of source and receiver pairs and outputs the predicted Green's functions.

In another aspect combinable with any of the previous aspects, the first neural network includes a U-network, and the second neural network includes a transformer network.

In another example implementation, one or more non-transitory, machine-readable storage devices storing instructions for generating seismic images of a subsurface formation, the instructions being executable by one or more processors, to cause performance of operations including obtaining seismic data representing the subsurface formation; generating velocity models for the subsurface formation based on the seismic data; predicting Green's functions for the subsurface formation using a neural network, where the inputs to the neural network comprise the velocity models; and generating seismic images of the subsurface formation based on the seismic data and the predicted Green's functions.

In an aspect combinable with the example implementation, the operations include determining one or more locations to drill wells in the subsurface formation based on the generated seismic images; and controlling drilling equipment to drill the wells in the one or more locations.

In another aspect combinable with any of the previous aspects, the operations include training the neural network based on a training data set including velocity models labeled with corresponding Green's functions.

In another aspect combinable with any of the previous aspects, the training data set includes synthetically generated velocity models derived from a geological model, and corresponding Green's functions determined based on a simulation of seismic wave propagation from a source location to a receiver location.

What is claimed is:

1. A method for generating seismic images of a subsurface formation, the method comprising:
obtaining seismic data representing the subsurface formation;
generating velocity models for the subsurface formation based on the seismic data;
predicting Green's functions for the subsurface formation using a neural network, where inputs to the neural network comprise the velocity models; and
generating seismic images of the subsurface formation based on the seismic data and the predicted Green's functions.

2. The method of claim 1, further comprising:
determining one or more locations to drill wells in the subsurface formation based on the generated seismic images; and
controlling drilling equipment to drill the wells in the one or more locations.

3. The method of claim 1, wherein generating the velocity models comprises generating the velocity models by applying a seismic tomography technique to the seismic data.

4. The method of claim 1, further comprising:
training the neural network based on a training data set comprising velocity models labeled with corresponding Green's functions.

5. The method of claim 4, wherein the training data set comprises synthetically generated velocity models and corresponding Green's functions.

6. The method of claim 5, wherein the synthetically generated velocity models are derived from a geological model, and the corresponding Green's functions are determined based on a simulation of seismic wave propagation from a source location to a receiver location.

7. The method of claim 1, wherein the neural network comprises a transformer network or a U-network.

8. The method of claim 1, wherein predicting the Green's functions for the subsurface formation comprises:
extracting features from the velocity models using a first neural network; and
generating wavefields using a second neural network,
wherein the first neural network takes as input the velocity models and outputs the extracted features, and
wherein the second neural network takes as input the extracted features and locations of source and receiver pairs and outputs the predicted Green's functions.

9. The method of claim 8, wherein the first neural network comprises a U-network, and the second neural network comprises a transformer network.

10. A system for generating seismic images of a subsurface formation, the system comprising:
at least one processor and a memory storing instructions that when executed by the at least one processor cause the at least one processor to perform operations comprising:
obtaining seismic data representing the subsurface formation;
generating velocity models for the subsurface formation based on the seismic data;
predicting Green's functions for the subsurface formation using a neural network, where inputs to the neural network comprise the velocity models; and
generating seismic images of the subsurface formation based on the seismic data and the predicted Green's functions.

11. The system of claim 10, wherein the operations further comprise:
determining one or more locations to drill wells in the subsurface formation based on the generated seismic images; and
controlling drilling equipment to drill the wells in the one or more locations.

12. The system of claim 10, wherein generating the velocity models comprises generating the velocity models by applying a seismic tomography technique to the seismic data.

13. The system of claim 10, wherein the operations further comprise: training the neural network based on a training data set comprising velocity models labeled with corresponding Green's functions.

14. The system of claim 13, wherein the training data set comprises:
synthetically generated velocity models derived from a geological model, and
corresponding Green's functions determined based on a simulation of seismic wave propagation from a source location to a receiver location.

15. The system of claim 10, wherein predicting the Green's functions for the subsurface formation comprises:
extracting features from the velocity models using a first neural network; and
generating wavefields using a second neural network,
wherein the first neural network takes as input the velocity models and outputs the extracted features, and
wherein the second neural network takes as input the extracted features and locations of source and receiver pairs and outputs the predicted Green's functions.

16. The system of claim 15, wherein the first neural network comprises a U-network, and the second neural network comprises a transformer network.

17. One or more non-transitory, machine-readable storage devices storing instructions for generating seismic images of a subsurface formation, the instructions being executable by one or more processors, to cause performance of operations comprising:
obtaining seismic data representing the subsurface formation;
generating velocity models for the subsurface formation based on the seismic data;
predicting Green's functions for the subsurface formation using a neural network, where inputs to the neural network comprise the velocity models; and
generating seismic images of the subsurface formation based on the seismic data and the predicted Green's functions.

18. The one or more non-transitory, machine-readable storage devices of claim 17, the operations further comprise:
determining one or more locations to drill wells in the subsurface formation based on the generated seismic images; and
controlling drilling equipment to drill the wells in the one or more locations.

19. The one or more non-transitory, machine-readable storage devices of claim 17, the operations further comprise:
training the neural network based on a training data set comprising velocity models labeled with corresponding Green's functions.

20. The one or more non-transitory, machine-readable storage devices of claim 19, wherein the training data set comprises:
synthetically generated velocity models derived from a geological model, and
corresponding Green's functions determined based on a simulation of seismic wave propagation from a source location to a receiver location.
